(19) United States
(12) Patent Application Publication
(10) Pub. No.: US 2026/0104710 A1
(43) Pub. Date: Apr. 16, 2026

(54) Robot System

(71) Applicant: ABB Schweiz AG, Baden (CH)

(72) Inventors: Fan Dai, Zwingenberg (DE); Christoph Byner, Mannheim (DE); Harald Staab, Neckargemünd (DE); Bjoern Matthias, Bad Schönborn (DE)

(73) Assignee: ABB Schweiz AG, Baden (CH)

(21) Appl. No.: 19/420,973

(22) Filed: Dec. 16, 2025

Related U.S. Application Data
(63) Continuation of application No. PCT/EP2023/066252, filed on Jun. 16, 2023.

(51) Int. Cl. G05D 1/622; B25J 5/00; B25J 9/16; G05D 111/10

(52) U.S. Cl. CPC G05D 1/637; B25J 5/007; B25J 9/1676; G05D 2111/10

(57) ABSTRACT

A robot system includes a robot having a sensor mounted thereon and a control unit, wherein the sensor acquires sensor data within at least one field of view, wherein the control unit defines or selects a volumetric safety zone located at a position relative to the robot; wherein the control unit controls the sensor to move such that the field of view covers the safety zone; wherein the control unit controls the robot to move in a movement direction; and wherein the control unit triggers a safety response upon detection of an object or body part of a human within the safety zone.

### CROSS-REFERENCE TO RELATED APPLICATIONS

The instant application claims priority to International Patent Application No. PCT/EP2023/066252, filed Jun. 16, 2023, which is incorporated herein in its entirety by reference.

### FIELD OF THE DISCLOSURE

The present invention disclosure generally to a robot system and method of controlling a robot.

### BACKGROUND OF THE INVENTION

Mobile robots usually have safety sensors which are fix-mounted on the vehicle. This limits the monitored space. Therefore, multiple sensors are often used to cover all regions around the mobile robot. This is not an optimal approach.

### BRIEF SUMMARY OF THE INVENTION

The present disclosure generally describes an improved mobile robot. In a first aspect, there is provided a robot system, comprising: a robot; a control unit; and at least one sensor. The at least one sensor is mounted on the robot. The at least one sensor is configured to acquire at least one sensor data within at least one field of view. Each sensor of the at least one sensor is configured to acquire sensor data within a field of view of the sensor. The control unit is configured to define or select a volumetric safety zone located at a position relative to the robot. The control unit is configured to control the at least one sensor to move such that the at least one field of view covers the safety zone. The control unit is configured to control the at least one part of the robot to move in a movement direction. The control unit is configured to trigger a safety response upon detection of an object or body part of a human within the safety zone.

### BRIEF DESCRIPTION OF THE SEVERAL VIEWS OF THE DRAWING(S)

FIG. 1 is a diagram of an example of a robot system in accordance with the disclosure.

FIG. 2 is a diagram of an example of a safety zone defined or selected by a control unit and a field of view of a sensor or sensors in accordance with the disclosure.

FIG. 3 is a diagram of an example of a robot system in accordance with the disclosure.

FIG. 4 is a diagram of an example of a robot system in accordance with the disclosure.

FIG. 5 is a diagram of an example of a robot system in accordance with the disclosure.

FIG. 6 is a diagram of an example of a robot system in accordance with the disclosure.

FIG. 7 is a diagram of an example of a robot system in accordance with the disclosure.

FIG. 8 is a chart of a detailed workflow of controlling a robot in accordance with the disclosure.

FIG. 9 is a pictorial representation of the workflow of FIG. 8.

### DETAILED DESCRIPTION OF THE INVENTION

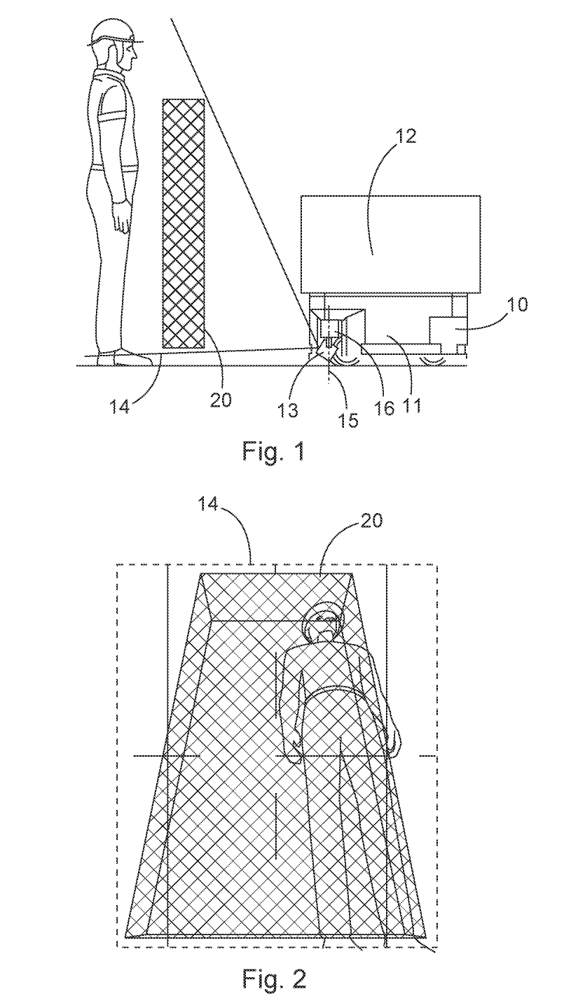

FIGS. 1-9 relate to a new robot system and method of controlling a robot.

In an example, a robot system comprises: a robot 11, a control unit 10, and at least one sensor 13. The at least one sensor is mounted on the robot. The at least one sensor is configured to acquire at least one sensor data within at least one field of view. Each sensor of the at least one sensor is configured to acquire sensor data within a field of view 14 of the sensor. The control unit is configured to define or select a volumetric safety zone 20, 21 located at a position relative to the robot. The control unit is configured to control the at least one sensor to move such that the at least one field of view covers the safety zone. The control unit is configured to control the at least one part of the robot to move in a movement direction. The control unit is configured to trigger a safety response upon detection of an object or body part of a human within the safety zone.

Thus, the new development relates to a mounting one or more sensors on a robot via one or more rotary and/or linear joints, controlling the joints by a control unit to change fields of views of the sensors such that an overall field of view provided by these sensors can be provided. An algorithm run by the control unit points the sensor in the direction of motion of the robot and/or a part of the robot. The control unit also has an algorithm that defines or selects safety zones depending on the current or planned motion of the robot. The control unit controls the sensors such that the overall field of view of the sensors observes the safety zones. In other words, a dynamic safety system for the robot is provided, where the at least one sensor continuously views where the robot or part of the robot is moving or planning to move, and observes a safety zone associated with such a movement of the robot enabling a safety response, such as a stopping of movement of the robot or part of the robot, or an alternative movement that mitigates any danger. In this way, a reduced number of sensors is required, and the robot can monitor itself as it carries out tasks, and it can do so safely.

The volumetric safety zone located at a position relative to the robot means that if the whole robot moves the safety zone moves with it. Also, a volumetric safety zone can be selected around the robot and its workspace, with respect to how a manipulator of a stationary robot can move. Thus, the robot itself does not intercept a volumetric safety zone, and the safety zone can be defined with respect to how the robot is or will be moving, such as being further from the robot when the whole robot is moving rapidly forward compared to when the whole robot is moving only slowly, and further spaced from a stationary robot when the manipulator is moving rapidly and with large movements as compared to the manipulator moving slowly with small movements. The safety zones are then monitored by sensors and if an object/human is detected within the safety zone, a safety response is triggered and this safety response trigger can be made further from the robot as the robot becomes potentially more dangerous. Thus, the safety zone can be considered to be volumetric safety zone encapsulating positions at which a human might be exposed to physical contact with any moving part of the robot that takes into account how the robot is or will be moving.

It is to be noted that reference to the control being configured to define or select a volumetric safety zone located at a position relative to the robot, also means that the control unit can select or define a number of volumetric safety zones at positions relative to the robot.

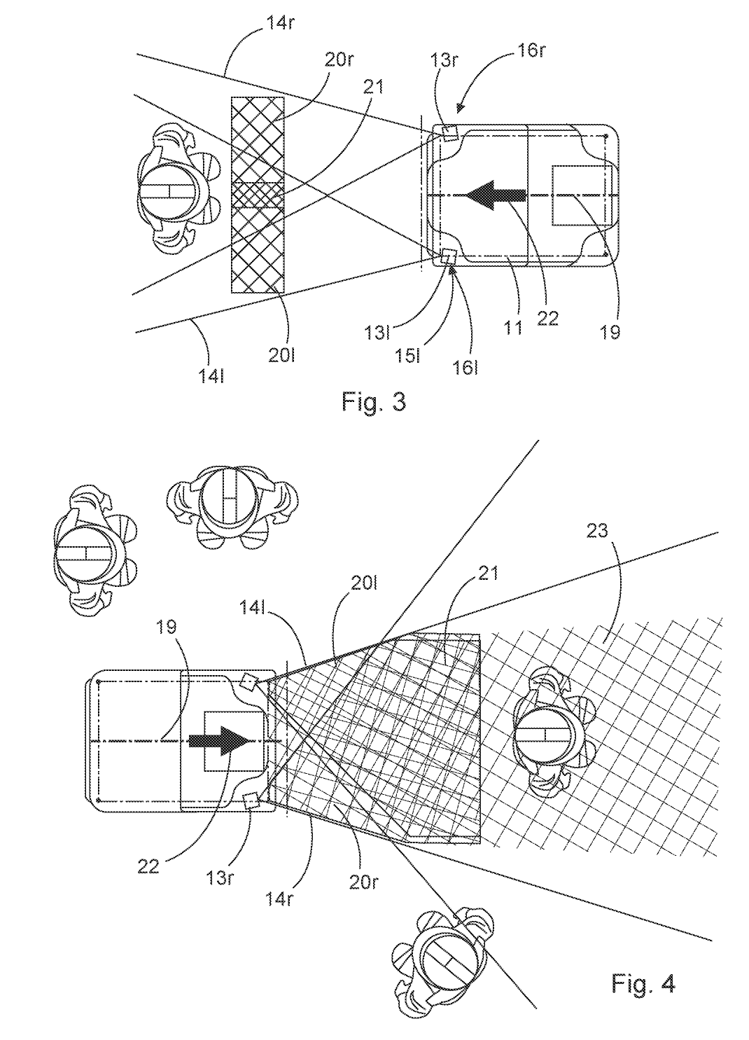

The following is a general description of an embodiment. As detailed above, a safety zone is a volume within the field of view of a sensor. The sensor includes optics, an element to convert the optical signals to electric signals (e.g. CCD chip), a computational unit to process the electric signals, and a signal interface—which in turn connects to for example the robot controller. The safety zone can be defined within the sensor’s computational unit, or defined in the robot controller. Usually two or more sensors are needed to monitor the entire volume next to the (mobile) robot in the direction of its motion, however in certain circumstances only one sensor is required. This volume plus a tolerance margin can then be used to define a safety zone. Therefore, the safety zone for the robot can spans across several sensors, which requires the safety zones defined in individual sensors to overlap. This is illustrated in FIG. 3, 4, 5, however there can be just one safety zone.

In an example, the control unit is mounted on the robot. In an example, the control unit is external to the robot and sensor data is transmitted to the control unit and commands are transmitted from the control unit to the robot. Thus, the robot can be completely autonomous, or relay sensor data to an external controller or control unit, and receive commands. Thus, for example a robot can be programmed for a task, and carry out that task and monitor its environment, such that for example if an object had been placed in its way or if a person walked into proximity of the robot the robot can take mitigating action if its next movement could lead to a dangerous situation. Also, a human operator could be controlling the robot via a wired or wireless communication, and what they plan the robot to do could inadvertently lead the robot into a dangerous situation or the human makes an input command error, such that the robot or part of the robot would encounter an object or human, the robot can take mitigating action.

According to an example, the at least one sensor comprises one or more cameras. In an example, there is one camera, mounted on a corner of a body of the robot or on a frame or stalk or manipulator of the robot.

In an example, there are two cameras, both mounted on corners of the body of the robot, or both mounted on a frame or stalk or manipulator of the robot, or one mounted on the body and one mounted on the frame or stalk or manipulator of the robot.

In an example, there are three cameras, all mounted on corners of the body of the robot, or all mounted on a frame or stalk or manipulator of the robot, or one mounted on the body and two mounted on the frame or stalk or manipulator of the robot, or two mounted on the body and one mounted on the frame or stalk or manipulator of the robot.

According to an example, the at least one sensor comprises one or more depth sensors. In an example, the at least one sensor comprises one or more time of flight cameras.

In an example, the at least one sensor comprises one or more lidar sensors. In an example, the at least one sensor comprises one or more radar sensors.

In an example, the at least one sensor comprises two cameras forming a stereo vision system.

In an example, the at least one sensor comprises one or more ultrasonic sensors.

According to an example, the movement of the at least one sensor comprises at least one linear movement in one or more cartesian axial directions. Thus, a sensor can move in x, y, and z directions, where it could for example be mounted on a manipulator of the robot.

According to an example, the movement of the at least one sensor comprises at least one rotational movement in one or more cartesian axial directions. Thus, a sensor can rotate vertically and/or horizontally to point in a required direction, and it could do so from a “fixed” location, for example on a corner of a body of the robot, or could do so from for example a manipulator, where the sensor could also be linearly translated as well as rotationally moved.

According to an example, the movement of the at least one part of the robot in the movement direction comprises a movement of a manipulator of the robot in the movement direction. This movement of the manipulator includes movement of attachments of the manipulator, such as end-of-arm tools, attached workpieces etc that can be taken into account with respect to defined safety zones.

According to an example, the movement of the at least one part of the robot in the movement direction comprises a movement of the robot in the movement direction. Thus, the robot system can monitor and ensure the safety of the entire movement of a mobile robot as it moves about in a location. Also, the robot system can monitor and ensure the safety of a fixed robot that moves for example a manipulator to carry out a task. Also, the robot system can monitor and ensure the safety of a mobile system as it moves about in a location and uses a manipulator to carry out a task.

According to an example, the control unit is configured to utilize an image processing algorithm to analyse the sensor data to detect the object or body part of the human within the safety zone.

In other words, radar sensor data, and/or visual image data, and/or depth camera data and/or lidar sensor data and/or ultrasonic sensor data can be analysed to determine if an object is present or if a human if present in the safety zone. An analysis can for example comprise a determination that an object is moving, and therefore likely to be a human, and an immediate stoppage of movement of the robot initiated. An analysis can be that an object is stationary and small and box shaped, and the control unit can determine to take mitigating action and navigate the robot around the object or move a manipulator around the object as required.

According to an example, the control unit is configured to define or select the volumetric safety zone comprising utilization of information on one or more planned tasks of the robot.

According to an example, the control unit is configured to define or select the volumetric safety zone comprising utilization of one or more instructions to move the at least one part of the robot. Thus, the control unit can know its task beforehand, and know exactly what movements will be made, and the safety zones can be pre-prepared and loaded for example from memory, and as each movement is being made the associated safety zone is utilized and the sensors are monitoring the space associated with the safety zone. Or, the robot could be operating autonomously and determining itself how to move in carrying out a task, or be provided with movement instructions from an operator, and as the robot is going to move it determines a safety zone that takes into account how it is moving and how it will move, for example how fast it is currently moving and in what direction and how fast and in what direction its next movement will be, and an associated safety zone is generated and the sensors monitor the space associated with the safety zone to ensure that the robot can carry out its task efficiently and safely.

According to an example, the control unit is configured to define a distance of a front edge of the volumetric safety zone in the movement direction comprising utilization of a speed and/or planned speed and/or braking performance of the at least one part of the robot.

According to an example, the at least one sensor comprises a first sensor 13l and a second sensor 13r. The control unit is configured to control the first sensor to move such that a field of view 14l of the first sensor covers a first part 20l of the safety zone and control the second sensor to move such that a field of view 14r of the second sensor covers a second part 20r of the safety zone.

According to an example, the control unit is configured to control the first sensor to move and control the second sensor to move such that both the field of view of the first sensor and the field of view of the second sensor cover a third part 21 of the safety zone that comprises a portion of the first part 20l of the safety zone and a portion of the second part 20l of the safety zone.

In an example, the at least one sensor comprises a third sensor 13c with a field of view. In an example, one or more of the at least one sensor is located at one or more different corners of the robot. In an example, one or more of the at least one sensor is located on one or more manipulators of the robot or one or more frames of the robot.

In an example, a method of controlling a robot is as described below. At least one sensor is mounted on the robot, and the method comprises: acquiring, by the at least one sensor, at least one sensor data within at least one field of view, wherein each sensor of the at least one sensor acquires sensor data within a field of view of the sensor; defining or selecting, by a control unit, a volumetric safety zone located at a position relative to the robot; controlling, by the control unit, the at least one sensor to move such that the at least one field of view covers the safety zone; controlling, by the control unit, the at least one part of the robot to move in a movement direction; and triggering, by the control unit, a safety response upon detection of an object or body part of a human within the safety zone.

In an example, the control unit is mounted on the robot. In an example, the control unit is external to the robot and sensor data is transmitted to the control unit and commands are transmitted from the control unit to the robot.

In an example, the at least one sensor comprises one or more cameras. In an example, the at least one sensor comprises one or more depth sensors. In an example, the at least one sensor comprises one or more time of flight cameras. In an example, the at least one sensor comprises one or more lidar sensors. In an example, the at least one sensor comprises one or more radar sensors. In an example, the at least one sensor comprises one or more ultrasonic sensors. In an example, the at least one sensor comprises two cameras forming a stereo vision system. In an example, the movement of the at least one sensor comprises at least one linear movement in one or more cartesian axial directions. In an example, the movement of the at least one sensor comprises at least one rotational movement in one or more cartesian axial directions. In an example, movement of the at least one part of the robot in the movement direction comprises a movement of a manipulator of the robot in the movement direction.

In an example, movement of the at least one part of the robot in the movement direction comprises a movement of the robot in the movement direction. In an example, the method comprises utilizing, by the control unit, an image processing algorithm to analyse the sensor data to detect the object or body part of the human within the safety zone. In an example, the control unit is configured to define or select the volumetric safety zone comprising utilization of information on one or more planned tasks of the robot.

In an example, the method comprises defining or selecting, by the control unit, the volumetric safety zone comprising utilizing one or more instructions to move the at least one part of the robot.

In an example, the method comprises defining, by the control unit, a distance of a front edge of the volumetric safety zone in the movement direction comprising utilizing a speed and/or planned speed and/or braking performance of the at least one part of the robot.

In an example, the at least one sensor comprises a first sensor 13l and a second sensor 13r, and the method step of controlling, by the control unit, the at least one sensor to move such that the at least one field of view covers the safety zone comprises: controlling, by the control unit, the first sensor to move such that the field of view 14l of the first sensor covers a first part 20l of the safety zone, and controlling, by the control unit, the second sensor to move such that the field of view 14r of the second sensor covers a second part 20r of the safety zone.

In an example, the method comprises controlling, by the control unit, the first sensor the second sensor to move such that both the field of view of the first sensor and the field of view of the second sensor cover a third part 21 of the safety zone that comprises a portion of the first part 20l of the safety zone and a portion of the second part 20l of the safety zone.

In an example, one or more of the at least one sensor is located at one or more different corners of the robot. In an example, one or more of the at least one sensor is located on one or more manipulators of the robot or one or more frames of the robot. The robot system and method of controlling a robot are now described in further specific detail, where reference is again made to FIGS. 1-9.

FIG. 1 shows an example embodiment of the robot system. The example embodiment of the system is shown from the side. The robot system comprises a mobile robot 11 with optional payload 12, which may protrude the footprint of the mobile robot. The robot system also comprises an optical sensor system 13, such as a ToF camera, which is mounted on a rotary joint 16 and which rotates the sensor about a rotation axis 15. The sensor 13 has a specific field of view (FoV) 14. The sensor is used to prevent collision of the mobile robot 11 including payload 12 with objects or persons, and therefore a safety zone 20 is defined. Detection of an object or body part within the safety zone 20 would trigger a safety response, usually a controlled stop of the robot.

FIG. 2 shows an example of a camera field of view and safety zone. A sensor system can cover 3D-space, such as through utilization of a time of flight (ToF) camera. FIG. 2 shows an example of the camera view of the illustration in FIG. 1, including the edges of the field of view 14 and a box-shaped safety zone 20.

FIG. 3 shows a plan view of a robot system. The example embodiment of the robot system is shown from the top, comprising a mobile robot 11, moving in the direction 22 of the longer symmetry axis 19. At the left and right corner there are cameras 13l, 13r each mounted on a rotary joint each 16l, 16r, allowing each camera to pan about a vertical axis 15. Each camera has a field of view (FoV) 14l, 14r. When moving in the direction as shown, both cameras roughly point in the same direction. The location of the overall safety zone, which has safety zones 20l, 20r for each camera, depends on the current speed and the braking performance of the robot. Preferably there is an overlap not only in the fields of view but also in the safety zones 21. Thus, in effect although there is only one overall safety zone, a safety zone can be defined in effect for each camera and if an object or person is detected in a safety zone for a camera the safety response can be initiated, irrespective of what the other camera is observing.

FIG. 4 shows a plan view of an example embodiment of the robot system, showing an example situation where the robot is moving forwards. The example embodiment of the robot system is shown from the top, comprising a mobile robot, moving in the direction 22 of the longer symmetry axis 19. This direction will make the robot occupy a certain floor space 23 which is continuously calculated and updated in the robot controller or control unit 10. In an embodiment the arrangement of the sensors entirely covers floorspace 23 and the volume above, but this is not required. This can be achieved by placing the cameras at the left and right corner 13l, 13r, and each mounted on a rotary joint, allowing each camera to pan. Each camera has a FoV 14l, 14r, and the combined FoV entirely covers the volume 23 except for a small triangular space right in front of the robot. The location of the safety zone 20l, 20r for each camera depends on the width of the floorspace 23 the robot will occupy, the current speed, and the braking performance of the robot. Optionally the pan angles of the cameras are set such that the near region ahead the motion direction is completely covered.

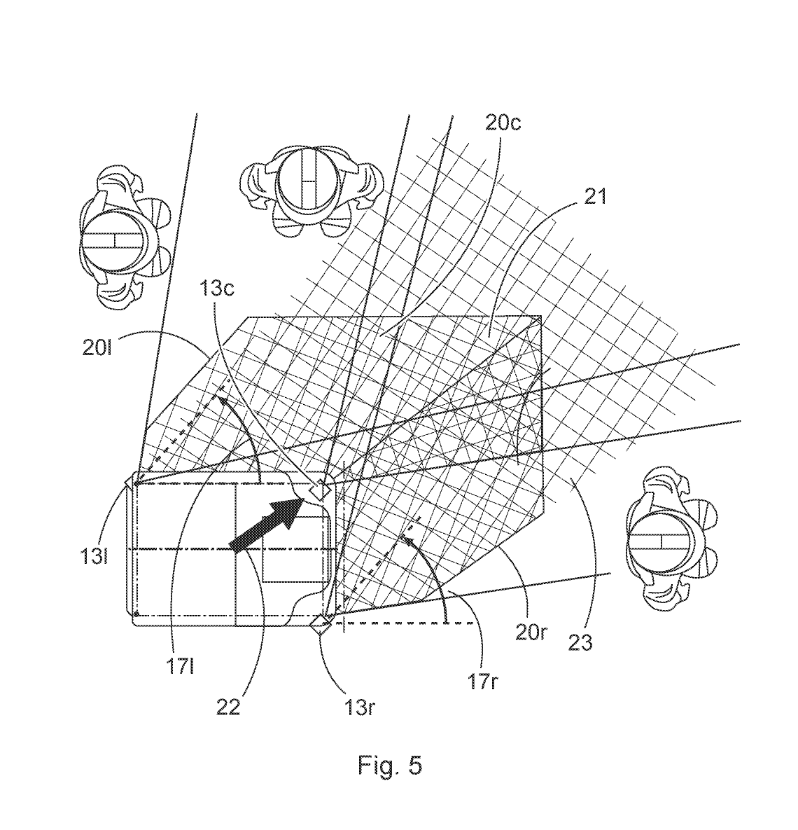

FIG. 5 shows a plan view of an example embodiment of the robot system, showing an example situation where the robot is moving sidewards. The example embodiment of the robot system is shown from the top, comprising a mobile robot which can also move sideways or diagonally (omnidirectional), moving in the direction 22 at an angle to the longer symmetry axis 19. This direction will make the robot occupy a certain floor space 23 which is continuously calculated and updated in the robot controller or control unit 10. There can be sensors in all 4 corners on a pan axis, but there can be fewer sensors and indeed only one in certain situations. This allows three of the sensors 13left (13l), 13 center (13c), 13right (13r) to monitor the floorspace 23 that the robot will occupy by moving through pan angles 17l, 17c, 17r. There is an overall safety zone formed from safety zones 20l, 20c, 20r defined for each sensor, and there are overlap zones 21 of two or all three sensors. The front edges of the safety zones 20l, 20c, 20r can align and represent the floorspace, which the robot would occupy after a safety stop plus some tolerance.

In FIGS. 3-5 the dashed rectangle generally shows corners where the sensors can be located.

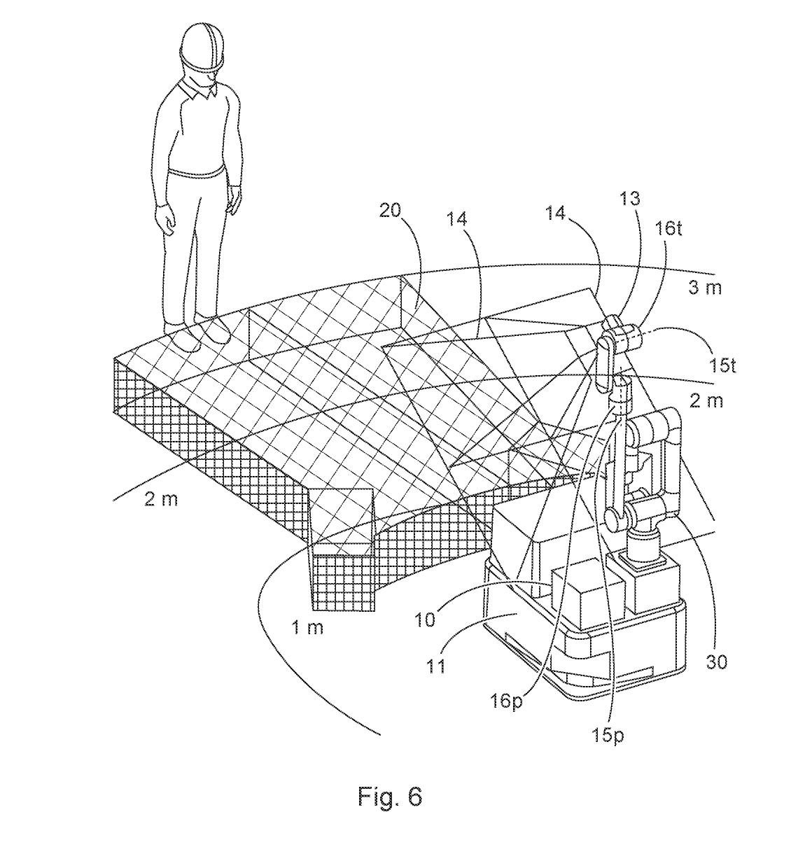

FIG. 6 shows an isometric view of an example embodiment of the robot system and an example situation. This example embodiment of the robot system comprises a mobile robot 11 with a robot manipulator 30, and a sensor mounted on an elevated pole on a pan joint 16p and a tilt joint 16t. The field of view 14 in this situation covers parts of the mobile robot as well as the space in front of the robot. An exemplary safety zone 20 is shown for fast forward motion. If the mobile robot 11 is omnidirectional then the pan joint 16p moves the camera to point in the direction of motion. For slower speeds of the mobile robot the tilt joint 16t points the camera further downwards, providing a ‘birds-eye’ view of the mobile robot, including some workspace of the manipulator 30. Preferably different safety zones are set around the manipulator.

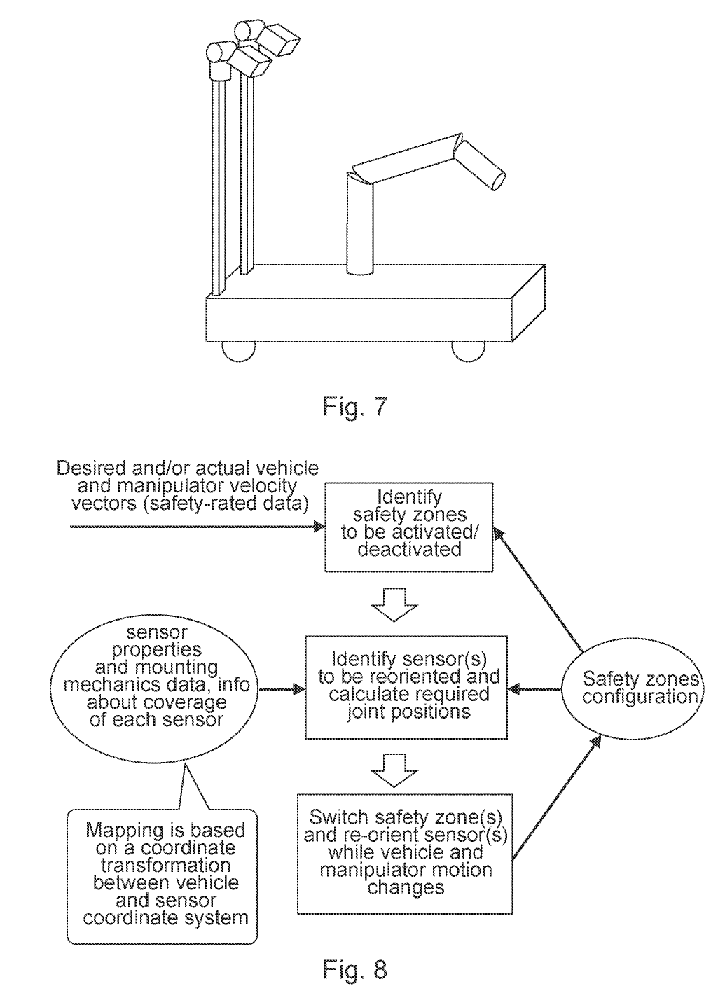

FIG. 7 shows an example of the robot system, where two cameras are mounted on elevated poles, with pan and tilt joints for each camera. FIG. 8 shows a detailed workflow of the control of a robot, and how safety zones are configured.

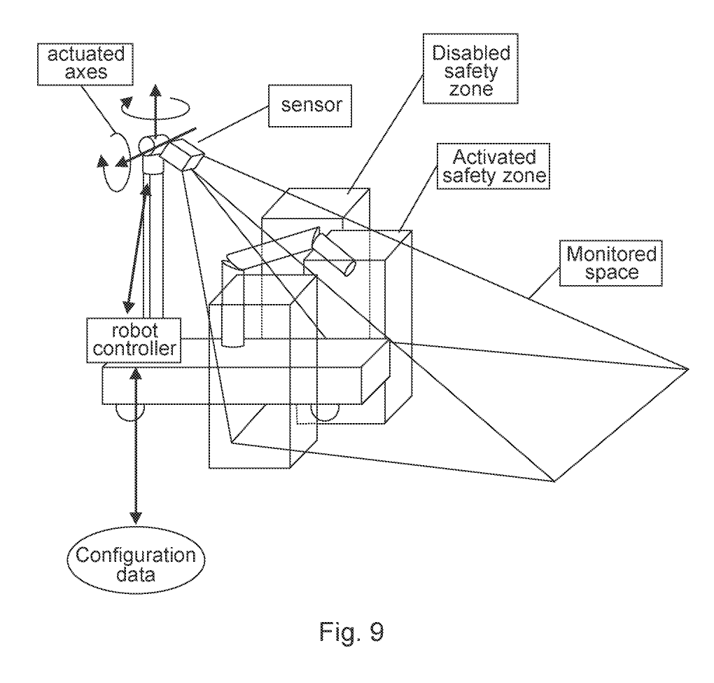

As shown in FIG. 9, and as described above, the robot system consists of a mobile robot with or without manipulator, with safety-rated control unit; a mounting for safety sensors with actuated axes, typically two (vertical and horizontal); a sensor mounted at the end of the mounting; a robot controller that controls the robot motion, including the actuated axes of the sensor mounting; optionally, the axes are controlled by a separate controller which is synchronized with the robot controller via safety-rated communication; a safety configuration containing information about the zones on or around the mobile robot to be observed by the sensor, including the configuration of assigned safety functions. They are activated accordingly by the safety controller based on safety-rated information of the mobile robot, e.g. Cartesian velocity of the manipulator TCP and the vehicle.

As shown in FIG. 9 the robot controller, or control unit 10, of the mobile robot uses configuration data to control the sensor, such as an optical sensor system 13. The monitored space is the field of view 14 of the sensor system and based on what the robot is doing and planning to do the activated safety zone is safety zone 20. There can be other defined safety zones 20 that can be activated, dependent upon the tasks of the robot, and these are shown as the disabled safety zones. There can be also more than one sensors mounted e.g. like a stereo pair of cameras. There can also be different combinations of numbers and locations of sensors and sensor mountings.

The axes are driven by a safety-rated control unit (that of the mobile robot, or a dedicated one with safe communication with it) using state of the art techniques regarding joint position sensing, communication, etc.

One or more safety zones are defined that cover together the full working space of the manipulator and/or the areas around the vehicle that must be monitored according to the safety design of the mobile robot and its applications.

The axes are controlled so that the field of view of the sensor covers the safety zone that is relevant and activated for the current state of the manipulator and/or the robot. Depending on the direction of robot motion (the robot and/or the manipulator), one or several zones are activated, and as a zone is activated other zones can be deactivated. Depending on the speed, a zone more extended to the motion direction may be activated. The axes of the sensor mounting is (synchronously) changed so that the right field of view is covering the zone to be supervised. The internal zone settings of the sensor system are actualized accordingly.

Thus, the new development is a robot system for sensor mounting with active axes, that can be synchronized to a mobile robot (incl. Manipulator) motion and is capable of monitoring the robot working space, and a corresponding method for configuring the safety zones and safety functions, is provided.

The robot system consists of: a mobile robot with or without manipulator, with safety-rated control unit; a mounting for safety sensors with actuated axes, typically two (vertical and horizontal); and a sensor mounted at the end of the mounting. There can be also more than one sensors mounted e.g. like a stereo pair of cameras. The axes are driven by a safety-rated control unit (that of the mobile robot, or a dedicated one with safe communication with it) using state of the art techniques regarding joint position sensing, communication, etc.

One or more safety zones are defined that cover together the full working space of the manipulator and/or the areas around the vehicle that must be monitored according to the safety design of the mobile robot and its applications. The axes are controlled so that the field of view of the sensor covers the safety zone that is relevant and activated for the current state of the manipulator and/or the robot.

In another exemplary embodiment, a computer program or computer program element is provided that is characterized by being configured to execute the method steps of the method according to one of the preceding embodiments, on an appropriate processor or system.

The computer program element might therefore be stored on a computer unit, which might also be part of an embodiment. This computing unit may be configured to perform or induce performing of the steps of the method described above. Moreover, it may be configured to operate the components of the above described system. The computing unit can be configured to operate automatically and/or to execute the orders of a user. A computer program may be loaded into a working memory of a data processor. The data processor may thus be equipped to carry out the method according to one of the preceding embodiments.

This exemplary embodiment covers both, a computer program that right from the beginning uses the invention and computer program that by means of an update turns an existing program into a program that uses the invention. Further on, the computer program element might be able to provide all necessary steps to fulfill the procedure of an exemplary embodiment of the method as described above.

According to a further exemplary embodiment, a computer readable medium, such as a CD-ROM, USB stick or the like, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

In an example, the at least one sensor comprises one or more cameras. In an example, the at least one sensor comprises one or more depth sensors. In an example, the movement of the at least one sensor comprises at least one linear movement in one or more cartesian axial directions. In an example, the movement of the at least one sensor comprises at least one rotational movement in one or more cartesian axial directions. In an example, the movement of the at least one part of the robot in the movement direction comprises a movement of a manipulator of the robot in the movement direction.

In an example, movement of the at least one part of the robot in the movement direction comprises a movement of the robot in the movement direction.

In an example, the control unit is configured to utilize an image processing algorithm to analyse the sensor data to detect the object or body part of the human within the safety zone.

In an example, the control unit is configured to define or select the volumetric safety zone comprising utilization of information on one or more planned tasks of the robot.

In an example, the control unit is configured to define or select the volumetric safety zone comprising utilization of one or more instructions to move the at least one part of the robot.

In an example, the control unit is configured to define a distance of a front edge of the volumetric safety zone in the movement direction comprising utilization of a speed and/or planned speed and/or braking performance of the at least one part of the robot.

In an example, the at least one sensor comprises a first sensor and a second sensor. The control unit is configured to control the first sensor to move such that the field of view of the first sensor covers a first part of the safety zone and control the second sensor to move such that the field of view of the second sensor covers a second part of the safety zone.

In an example, the control unit is configured to control the first sensor to move and control the second sensor to move such that both the field of view of the first sensor and the field of view of the second sensor cover a third part of the safety zone that comprises a portion of the first part of the safety zone and a portion of the second part of the safety zone.

In a second aspect, there is provided a method of controlling a robot. At least one sensor is mounted on the robot. The method comprises: acquiring, by the at least one sensor, at least one sensor data within at least one field of view, wherein each sensor of the at least one sensor acquires sensor data within a field of view of the sensor; defining or selecting, by a control unit, a volumetric safety zone located at a position relative to the robot; controlling, by the control unit, the at least one sensor to move such that the at least one field of view covers the safety zone; controlling, by the control unit, the at least one part of the robot to move in a movement direction; and triggering, by the control unit, a safety response upon detection of an object or body part of a human within the safety zone.

According to another aspect, there is provided a computer program element controlling one or more of the systems as previously described which, if the computer program element is executed by a processor, is adapted to perform the method as previously described.

According to another aspect, there is provided a computer readable medium having stored a computer element as previously described.

The computer program element can for example be a software program but can also be a FPGA, a PLD or any other appropriate digital means.

The above aspects and examples will become apparent from and be elucidated with reference to the embodiments described hereinafter.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### Reference Numerals

10 Control unit

11 Mobile robot

12 Payload

13 Optical sensor system

13l Camera – mounted at left

13r Camera – mounted at right

13c Camera – mounted at center

14 Field of view of sensor system 13

14l Field of view of camera 13l

14r Field of view of camera 13r

15 rotation axis of sensor system 13

16 Rotary joint of sensor system 13

16p pan rotary joint of sensor system 13

16t tilt joint of sensor system 13

17l Pan angle of camera 13l

17r Pan angle of camera 13r

17c Pan angle of camera 13c

19 Axis of mobile robot 11

20 Safety zone

20l Safety zone defined w.r.t camera 13l

20r Safety zone defined w.r.t camera 13r

20c Safety zone defined w.r.t camera 13c

21 Safety zone overlap of safety zone 20l and safety zone 20r or Safety zone overlap of safety zone 20l and safety zone 20r and safety zone 20c

22 Movement direction of mobile robot 11

23 Area or volume next to mobile robot 11 in the direction of movement 22 which the mobile robot 11 will occupy

30 Manipulator of mobile robot 11

What is claimed is:

1. A robot system, comprising:
a robot;
a control unit; and
at least one sensor;
wherein the at least one sensor is mounted on the robot;
wherein the at least one sensor is configured to acquire at least one sensor data within at least one field of view, wherein each sensor of the at least one sensor unit is configured to acquire sensor data within a field of view of the sensor;
wherein the control unit is configured to define or select a volumetric safety zone located at a position relative to the robot;
wherein the control unit is configured to control the at least one sensor to move such that the at least one field of view covers the safety zone;
wherein the control unit is configured to control the at least one part of the robot to move in a movement direction; and
wherein the control unit is configured to trigger a safety response upon detection of an object or body part of a human within the safety zone.

2. The robot system according to claim 1, wherein the at least one sensor comprises one or more cameras.

3. The robot system according to claim 1, wherein the at least one sensor comprises one or more depth sensors.

4. The robot system according to claim 1, wherein the movement of the at least one sensor comprises at least one linear movement in one or more cartesian axial directions.

5. The robot system according to claim 1, wherein the movement of the at least one sensor comprises at least one rotational movement in one or more cartesian axial directions.

6. The robot system according to claim 1, wherein movement of the at least one part of the robot in the movement direction comprises a movement of a manipulator of the robot in the movement direction.

7. The robot system according to claim 1, wherein movement of the at least one part of the robot in the movement direction comprises a movement of the robot in the movement direction.

8. The robot system according to claim 1, wherein the control unit is configured to utilize an image processing algorithm to analyze the sensor data to detect the object or body part of the human within the safety zone.

9. The robot system according to claim 1, wherein the control unit is configured to define or select the volumetric safety zone comprising utilization of information on one or more planned tasks of the robot.

10. The robot system according to claim 1, wherein the control unit is configured to define or select the volumetric safety zone comprising utilization of information on one or more instructions to move the at least one part of the robot.

11. The robot system according to claim 1, wherein the control unit is configured to define a distance of a front edge of the volumetric safety zone in the movement direction comprising utilization of a speed and/or planned speed and/or braking performance of the at least one part of the robot.

12. The robot system according to claim 1, wherein the at least one sensor comprises a first sensor and a second sensor, and wherein the control unit is configured to control the first sensor to move such that a field of view of the first sensor covers a first part of the safety zone and control the second sensor to move such that a field of view of the second sensor covers a second part of the safety zone.

13. The robot system according to claim 12, wherein the control unit is configured to control the first sensor to move and control the second sensor to move such that both the field of view of the first sensor and the field of view of the second sensor cover a third part of the safety zone that comprises a portion of the first part of the safety zone and a portion of the second part of the safety zone.

14. A method of controlling a robot, wherein at least one sensor is mounted on the robot, and wherein the method comprises:
acquiring, by the at least one sensor, at least one sensor data within at least one field of view, wherein each sensor of the at least one sensor acquires sensor data within a field of view of the sensor;
defining or selecting, by a control unit, a volumetric safety zone located at a position relative to the robot;
controlling, by the control unit, the at least one sensor to move such that the at least one field of view covers the safety zone;
controlling, by the control unit, the at least one part of the robot to move in a movement direction; and
triggering, by the control unit, a safety response upon detection of an object or body part of a human within the safety zone.

15. A computer program element that includes computer executable instructions that, when executed by a computer, carry out a method of controlling a robot, wherein at least one sensor is mounted on the robot, and wherein the method comprises:
instructions for acquiring, by the at least one sensor, at least one sensor data within at least one field of view, wherein each sensor of the at least one sensor acquires sensor data within a field of view of the sensor;
instructions for defining or selecting, by a control unit, a volumetric safety zone located at a position relative to the robot;
instructions for controlling, by the control unit, the at least one sensor to move such that the at least one field of view covers the safety zone;
instructions for controlling, by the control unit, the at least one part of the robot to move in a movement direction; and
instructions for triggering, by the control unit, a safety response upon detection of an object or body part of a human within the safety zone.
